(19) United States
(12) Patent Application Publication
(10) Pub. No.: US 2010/0200513 A1
(43) Pub. Date: Aug. 12, 2010

(54) SURFACE SEPARATION SYSTEM FOR SEPARATING FLUIDS

(75) Inventors: Dwayne Cartier, Beaumont (CA); Matthew R. Hackworth, Manvel, TX (US); Ryan Cox, Sugar Land, TX (US); Matthew Garber, Sugar Land, TX (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, SUGAR LAND, TX (US)

(21) Appl. No.: 12/628,782

(22) Filed: Dec. 1, 2009

Related U.S. Application Data
(60) Provisional application No. 61/150,841, filed on Feb. 9, 2009.

(51) Int. Cl. B01D 21/34; C02F 1/00

(52) U.S. Cl. 210/739; 210/137

(57) ABSTRACT

The present application relates to a surface separation system used to separate fluids such as oil, gas, water, and/or sand slurry produced from a well. The separation system may include a pumping system, such as a horizontal pumping system (HPS), a separator, and flow control hardware. The separator system may be mounted on a skid or incorporated directly into a production flow. The separator system may be used in conjunction and/or in parallel with a conventional surface separation facility.

### CROSS-REFERENCE TO OTHER APPLICATIONS

This application claims priority to and the benefit of U.S. Provisional Application Ser. No. 61/150841, filed on Feb. 9, 2009.

### BACKGROUND OF INVENTION

1. Field of the Invention

The present application relates generally to the field of separating fluids produced from a well, such as oil, gas, and/or water, and particularly to a surface separation system that separates and routes the fluid components.

2. Background Art

Oil well production typically involves bringing significant volumes of undesired fluid (e.g., salt water) to the surface. This “produced water” often accounts for 80 to 90 percent, or more, of the total well fluid volume produced, creating significant operational issues and expense for producers.

The produced water generally must be treated and re-injected to a subterranean reservoir, both for disposal and to maintain reservoir pressure. Because treatment facilities are typically extensive and expensive, they are generally housed in a central facility. This requires transporting the produced fluids, usually by pipeline, to and from the treatment facility. Transporting, treating, and disposing of produced water can cost anywhere from a few cents to several dollars per barrel. In some instances, transporting great distances creates bottlenecks, is highly inefficient, and becomes cost-prohibitive.

In certain cases fluid separation can be performed downhole before the undesired fluid is brought to the surface. However, in other cases that is not be feasible due to, for example, cost, operational complexities (e.g., unconsolidated sand, excess volume of gas, or casing size), or lack of an adequate injection zone within the subject well. In those instances, alternative treatment and disposal is required.

### SUMMARY

The present application relates to a surface separation system used to separate fluids such as oil, gas, water, and/or sand slurry produced from a well. The separation system may include a pumping system, such as a horizontal pumping system (HPS), a separator, and flow control hardware. The separator system may be mounted on a skid or incorporated directly into a production flow. The separator system may be used in conjunction and/or in parallel with a conventional surface separation facility.

Other aspects and advantages will become apparent from the following description and the attached claims.

### BRIEF DESCRIPTION OF THE FIGURES

FIG. 1 is a schematic drawing showing various components comprising one embodiment of a horizontal pumping system.

FIG. 2 is a schematic drawing showing a separation system used in accordance with an embodiment described in the instant disclosure.

FIG. 3 is a schematic drawing showing certain components of the separation system of FIG. 2.

FIG. 4 is a schematic drawing showing a separation system used in accordance with an embodiment described in the instant disclosure.

FIG. 5 is a schematic drawing showing certain components of the separation system of FIG. 4.

FIG. 6 is a schematic drawing showing, in plan view, a separation system used in accordance with an embodiment described in the instant disclosure.

FIG. 7 is a schematic drawing showing, in plan view, a separation system used in accordance with an embodiment described in the instant disclosure.

FIG. 8 is a schematic drawing showing, in elevation view, a separation system used in accordance with an embodiment described in the instant disclosure.

It is to be understood that the drawings are to be used for the purpose of illustration only, and not as a definition of the metes and bounds of the invention, the scope of which is to be determined only by the scope of the appended claims.

### DETAILED DESCRIPTION

Specific embodiments of the invention will now be described with reference to the figures. Like elements in the various figures will be referenced with like numbers for consistency. In the following description, numerous details are set forth to provide an understanding of the present invention. However, it will be understood by those skilled in the art that the present invention may be practiced without many of these details and that numerous variations or modifications from the described embodiments are possible. As used here, the terms “above” and “below”; “up” and “down”; “upper” and “lower”; “upwardly” and “downwardly”; and other like terms indicating relative positions above or below a given point or element are used in this description to more clearly describe some embodiments of the invention. However, when applied to equipment and methods for use in wells that are deviated or horizontal, such terms may refer to a left to right, right to left, or diagonal relationship as appropriate.

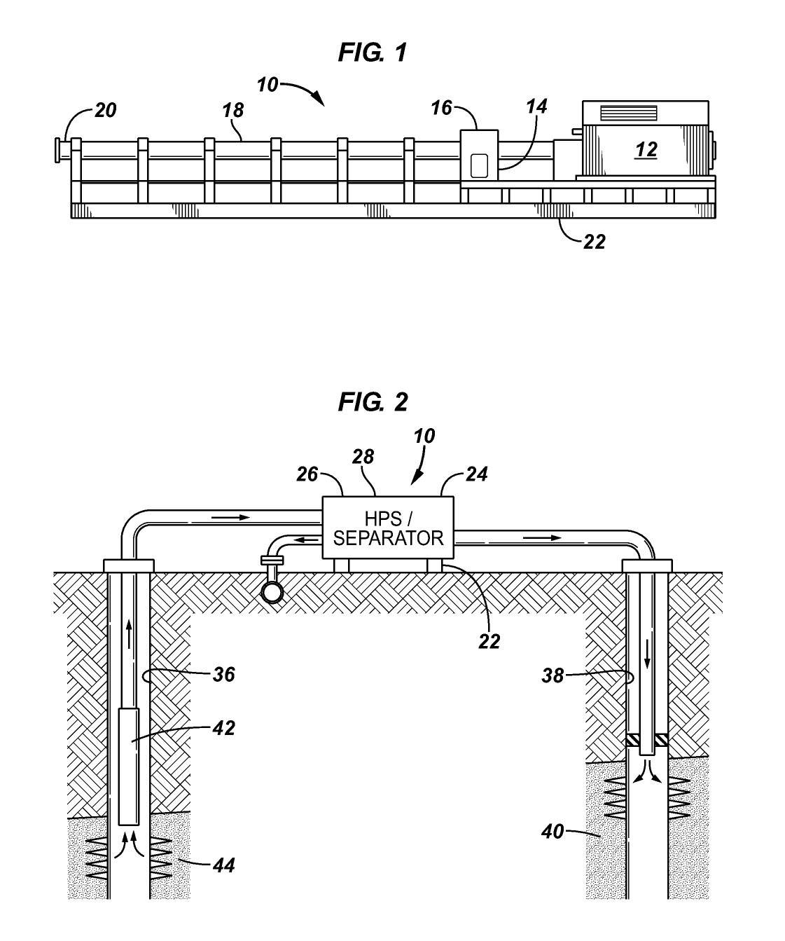

FIG. 1 shows various components of a standard Horizontal Pumping System (HPS) 10. HPS 10 includes a motor 12 (e.g., a 480 volt ac motor), a thrust chamber 14, an intake 16, a pump 18, and a discharge 20, all mounted on mounting skid 22. Motor 12 is coupled to and drives pump 18 via thrust chamber 14. Thrust chamber 14 has thrust bearings (not illustrated) to carry, for example, the axial down thrust loads produced by the pumping action of pump 18, and transmits the motor torque to pump 18. Fluids such as separated water, for example, may be provided to intake 16 and pump 18 pressurizes the fluid to propel it out discharge 20 so that it may be injected into a pipeline or suitable formation. As indicated above, the HPS illustrated is a standard configuration, but many variations and hardware combinations are possible. Other pumping systems may also be substituted for the HPS.

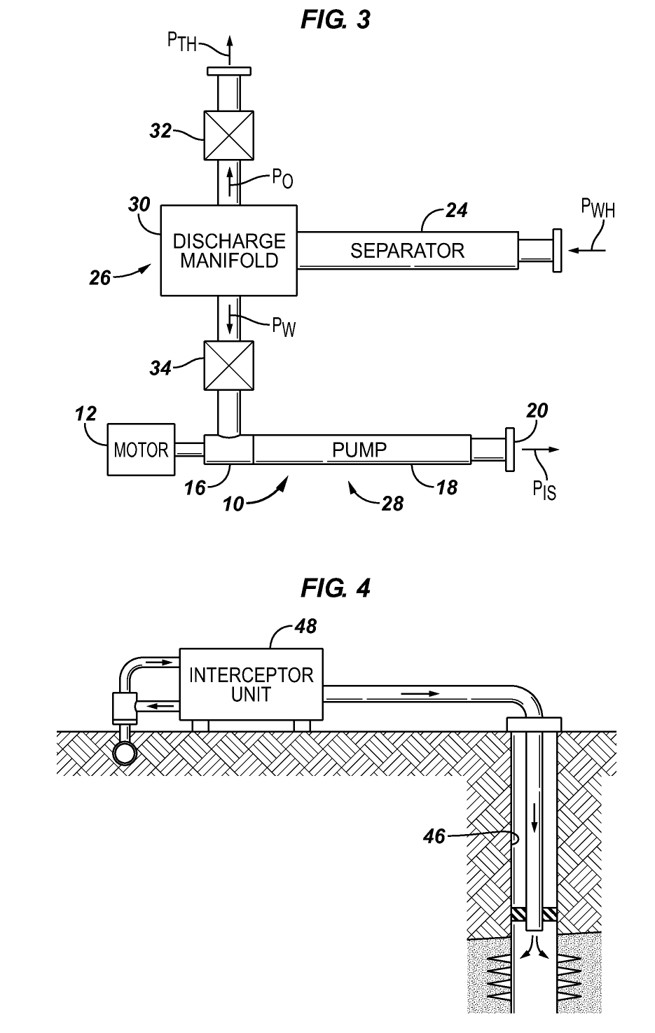

HPS 10 can be coupled to a separator 24, as shown in FIG. 2. Separator 24 may, for example, be a multi-liner, parallel hydrocyclone unit, as is know in the art. Hydrocyclone units have previously been connected in parallel to create high capacity oil-water separators. Separator 24 may also comprise sand and gas separators to further condition the production flow for effective separation and injection. There are many ways to couple a separation system together, but preferably the system includes an HPS 10, a separator 24, and flow control hardware 26. One such system, all mounted on skid 22, will be referred to herein as a separator skid 28. Flow control hardware 26 may comprise, for example, a discharge manifold 30, an oil choke 32, and a water choke 34, as shown in FIG. 3.

As stated, there are multiple ways of configuring a separation system. For example, it may be configured to operate in a “brown field” application. FIG. 2 shows a separator skid 28 coupled to a producing well 36 and an injection well 38, or at least a well having an injection zone 40. A conventional ESP 42 is disposed in or near a producing zone 44 in producing well 36.

Separator skid 28, as shown in FIG. 3, receives production flow at the wellhead pressure, P_{WH}. Generally the produced fluid pressure or well head pressure ranges between 50 and 1,000 psi, and typically is approximately 150 psi, depending upon flow rate, tubing sizes, and operator preferences. The well head pressure is either provided or augmented by ESP 42.

As further shown in FIG. 3, in operation, the produced fluids pass through oil-water separator 24, where they are separated, and the separated fluids pass into discharge manifold 30. The oil phase is discharged from discharge manifold 30 at the separator oil discharge pressure, P_{O}, and passes through oil choke 32 into the field lines. The oil leaves oil choke 32 and enters the field lines at the tubing head pressure, P_{TH}.

The separated water is discharged from discharge manifold 30 at the separator water discharge pressure, P_{W}, and passes through water choke 34 into intake 16 of HPS 10. Pressure is provided to the water by pump 18 and the water leaves discharge 20 at the injection well surface pressure, P_{IS}. The pressure, P_{I}, of the water when delivered to injection zone 40 is the sum of the injection well surface pressure and the hydrostatic pressure of the water column, less any pressure losses occurring along the length of the transport tubing.

The well head pressure must be sufficient to overcome various pressure drops that may be experienced by the produced fluids. The pressure drops may occur, for example, due to the action of separator 24, the passage of fluids through discharge manifold 30, passing through oil or water chokes 32, 34 (e.g., P_{O}>P_{TH}), agency-regulated requirements for water boost pumps, or, for the oil phase, field flow line pressure. For example, the separator water discharge pressure, P_{W}, is required by current regulation to be greater than or equal to 30 psi. Thus, the well head pressure must be high enough so that the encountered pressure drops do not reduce the separator water discharge pressure below 30 psi unless auxiliary pressure boosters are provided.

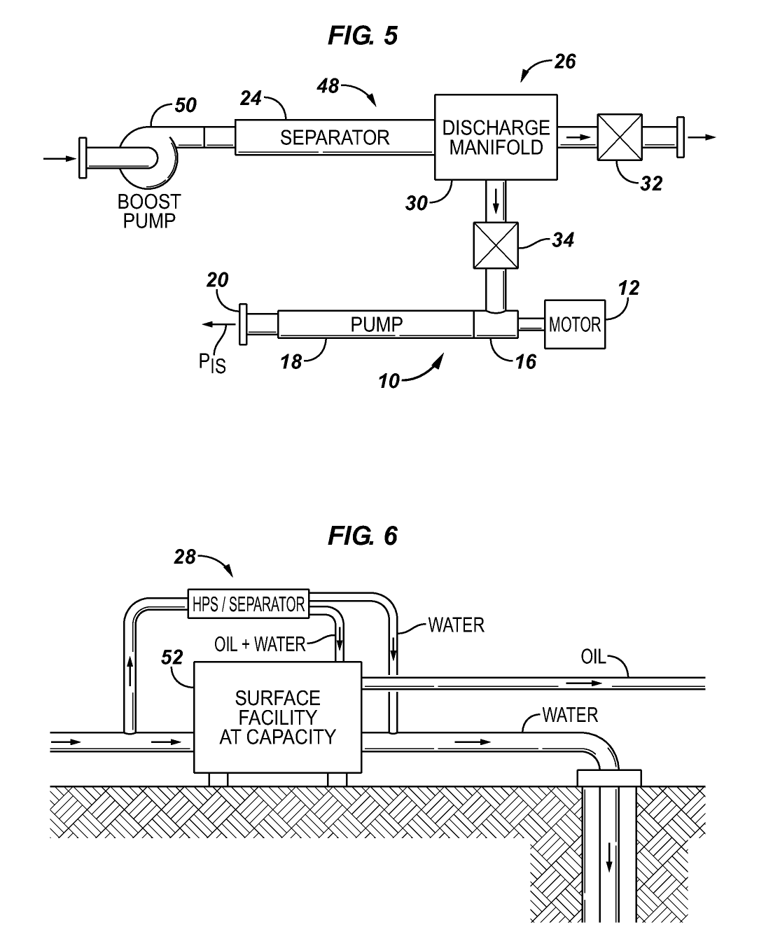

An alternate embodiment uses a single disposal well 46, as shown in FIG. 4. Disposal well 46 may be, for example, a dedicated injection well, a production well having a suitable open zone, or a “watered-out” production well in which water is injected to maintain pressure in the producing zone. In this embodiment, oil from the field's existing flow lines is tapped into and routed to a separator unit 48 located near disposal well 46. Separator unit 48 (see FIG. 5) is similar to separator skid 28 in that it comprises a separator 24, an HPS 10, and flow control hardware 26, but the components may not be mounted on skid 22. Flow control hardware 26 again comprises, for example, a discharge manifold 30, an oil choke 32, and a water choke 34. Because of the similarities between separation skid 28 and separator unit 48, those terms may be used interchangeably. The term “separation system”, as used herein, refers to and encompasses both.

Oil tapped from the field lines and routed to separator unit 48 is passed to separator 24, or, optionally, fed to a boost pump 50 before being passed to separator 24. Separated oil passes from discharge manifold 30 through oil choke 32 and is returned to the field lines. Separated water passes from discharge manifold 30 through water choke 34 and into intake 16 of HPS 10. The water is pumped under pressure through discharge 20 and into disposal well 46.

Similarly, a separator unit 48 or separator skid 28 may be located near a tank battery (not shown) instead of a disposal well 46. Oil from the field lines or tanks is processed as described above and the separated oil is returned to the field lines or tanks. The separated water is discharged into a field-wide injection flow system. This would likely require an additional injection pump be located at the well site. The separator skid 28 or separator unit 48 could remove some of the loading from the existing battery facilities.

A separation skid 28 may also be used in parallel or in conjunction with conventional surface separation or treatment facilities, as shown in FIGS. 6, 7, and 8. FIG. 6 shows a separation skid 28 deployed in parallel with a conventional surface separation facility 52. Such a configuration may be desirable, for example, to alleviate temporary bottlenecks at a surface separation facility 52 operating at full capacity. Separated oil from separator skid 28 can be routed back to the incoming production line into surface separation facility 52 or on to the next processing stage. Water from separator skid 28 is routed to a disposal or injection site.

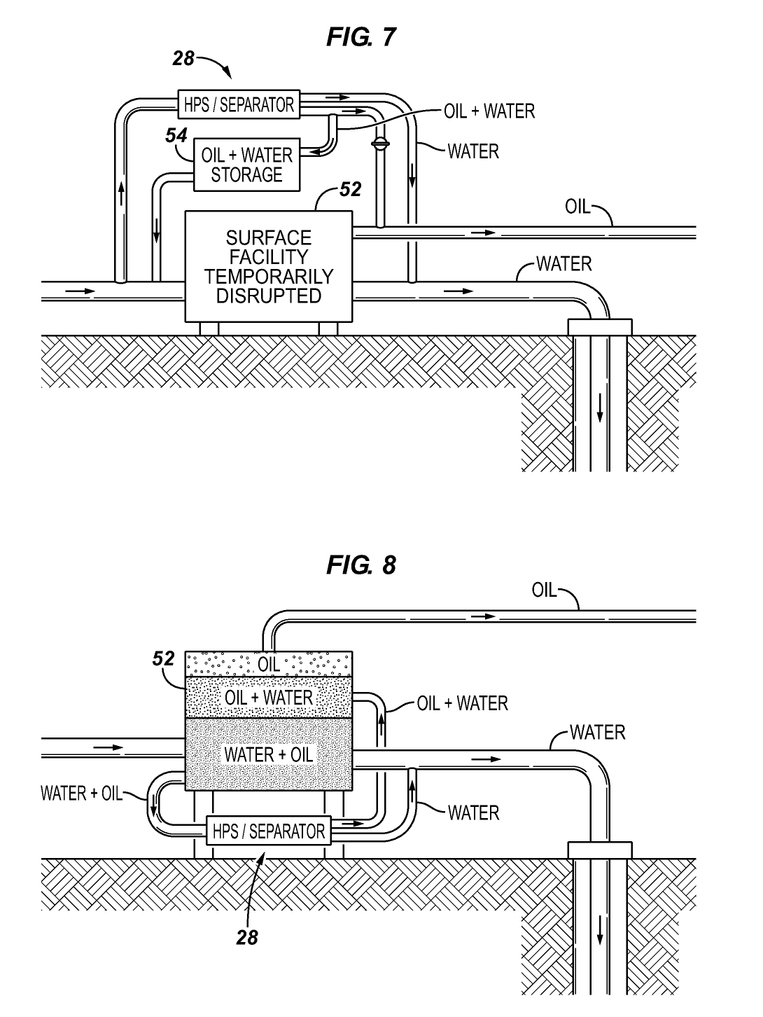

Similarly, as shown in FIG. 7, a separation skid 28 may be deployed, in conjunction with a temporary storage medium 54, at a surface treatment facility 52 when a disruption in the normal treatment process occurs. Oil from separator skid 28 can be routed to temporary storage medium 54 until the surface treatment facility 52 is returned to operation, or on to the next processing stage. Water from the separator skid 28 is routed to a disposal or injection site.

A separation skid 28 may also be deployed in conjunction with a surface separation facility 52 to enhance or accelerate produced water treatment, as shown in FIG. 8. For example, the oil discharge from separator skid 28 may be part of a re-circulated treatment loop. That is, the oil phase from separator skid 28 is returned to the next stage of separation in surface separation facility 52, such as the oil-rich layer in the free water knockout. Water from separator skid 28 is routed to a disposal or injection site.

While the invention has been described with respect to a limited number of embodiments, those skilled in the art, having benefit of this disclosure, will appreciate that other embodiments can be envisioned that do not depart from the scope of the invention as disclosed herein. Accordingly, the scope of the invention shall be limited only by the attached claims.

What is claimed is:

1. A separation system, comprising: a pumping system; a separator; and flow control hardware.

2. The separation system of claim 1, wherein the pumping system is a horizontal pumping system (HPS) comprising a motor, a thrust chamber, an intake, a pump, and a discharge.

3. The separation system of claim 2, further comprising a skid on which the HPS, separator, and flow control hardware are mounted.

4. The separation system of claim 1, wherein the separator is an oil-water separator, a sand separator, or a gas separator.

5. The separation system of claim 1, wherein the separator comprises one or more hydrocyclone oil-water separation units.

6. The separation system of claim 1, wherein the flow control hardware comprises a discharge manifold, an oil choke, and a water choke.

7. The separation system of claim 1, further comprising a electric submersible pump (ESP).

8. A method to separate fluids, comprising:
providing a separation system comprising a pumping system, a separator, and flow control hardware;
inputting production fluids into the separator;
outputting first and second separated fluids from the separator into the flow control hardware;
discharging the first separated fluid into field lines or a storage facility;
discharging the second separated fluid into the pumping system; and
discharging the second separated fluid from the pumping system into a disposal site.

9. The method of claim 8, wherein the disposal site is an injection well, a production well having a suitable open zone, or a watered-out production well.

10. The method of claim 8, wherein the inputting production fluids comprises using an electric submersible pump disposed in a well or tapping into field lines.

11. The method of claim 10, further comprising providing one or more boost pumps and boosting the pressure of the production fluids using the boost pump(s).

12. A method to separate fluids, comprising:
providing a separation system comprising a pumping system, a separator, and flow control hardware;
locating the separation system near a tank battery comprising feed tanks and storage tanks;
inputting fluids from one or more of the feed tanks into the separator;
outputting first and second separated fluids from the separator into the flow control hardware;
discharging the first separated fluid into field lines or one or more of the storage tanks;
discharging the second separated fluid into the pumping system; and
discharging the second separated fluid from the pumping system into an injection flow system.

13. The method of claim 12, further comprising providing an injection pump located at a disposal site and injecting the second fluid from the injection flow system into the disposal site using the injection pump.

14. The method of claim 13, wherein the disposal site is an injection well, a production well having a suitable open zone, or a watered-out production well.

15. A method to separate fluids, comprising:
providing a separation system comprising a pumping system, a separator, and flow control hardware;
locating the separation system near a conventional surface separation facility; and
operating the separation system in parallel with the conventional surface separation facility.

16. The method of claim 15, wherein the operating the separation system in parallel with the conventional surface separation facility comprises:
taking some or all of the production fluids into the separation system;
routing a first separated fluid from the separation system into an incoming production line of the conventional surface separation facility or to a next processing stage; and
discharging a second separated fluid from the separation system into a disposal site.

17. The method of claim 15, further comprising providing a temporary storage facility and wherein the operating the separation system in parallel with the conventional surface separation facility comprises:
taking some or all of the production fluids into the separation system;
routing a first separated fluid from the separation system into the temporary storage facility or to a next processing stage; and
discharging a second separated fluid from the separation system into a disposal site.

18. The method of claim 17, further comprising passing the first separated fluid from the storage tank to the conventional surface separation facility.

19. The method of claim 15, further comprising enhancing or accelerating produced water treatment.

20. The method of claim 19, wherein the enhancing or accelerating produced water treatment comprises:
taking some or all of a first treated fluid from a first processing stage of the conventional surface separation facility into the separation system;
routing a first separated fluid from the separation system into a second processing stage of the conventional surface separation facility; and
discharging a second separated fluid from the separation system into a disposal site.
